(19) United States
(12) Patent Application Publication
(10) Pub. No.: US 2003/0135611 A1
(43) Pub. Date: Jul. 17, 2003

(54) Self-monitoring service system with improved user administration and user access control

(76) Inventors: Dean Kemp, Superior, CO (US); Dario Atallah, Louisville, CO (US); Clement Ng, Toronto (CA); Hong Yu, Markham (CA)

Correspondence Address: HOGAN & HARTSON LLP, ONE TABOR CENTER, SUITE 1500, 1200 SEVENTEEN ST., DENVER, CO, 80202, US

(21) Appl. No.: 10/179,740

(22) Filed: Jun. 25, 2002

Related U.S. Application Data
(60) Provisional application No. 60/348,662, filed on Jan. 14, 2002.
(60) Provisional application No. 60/377,173, filed on Apr. 30, 2002.

(51) Int. Cl. G06F 15/173; G06F 15/16

(52) U.S. Cl. 709/224; 709/229

(57) ABSTRACT

A method and associated system for providing customer-directed user administration within a system monitoring environment. The method includes assigning customer users differing privileges for user administration based on an assigned user class. A root administrator class has administration privileges to view gathered data for the entire monitored environment and administer users in the entire environment by adding or modifying users with less administration privileges, such as domain administrators and viewers. Users may be assigned as domain administrators and viewers of one or more domain within the environment. Domain administrators can view system data within the assigned domain and administer users within the domain, including viewers and domain administrators. Viewers can view system data within the assigned domain. Users being assigned to multiple domains filter the reported data by selecting a subset of the domains for monitoring.

### CROSS-REFERENCE TO RELATED APPLICATIONS

This application claims the benefit of U.S. Provisional Application No. 60/348,662, filed Jan. 14, 2002, and U.S. Provisional Application No. 60/377,173, filed Apr. 30, 2002, the disclosures of which are herein specifically incorporated in their entirety by this reference.

### BACKGROUND OF THE INVENTION

1. Field of the Invention

The present invention relates, in general, to monitoring, reporting, and asset tracking software and systems, and more particularly, to a method and system for administering the number of users of an self-monitoring service system and the access privileges given to each such user, with many of the user administration and access control functions being distributed among the clients of the service system.

2. Relevant Background

The need for effective and cost efficient monitoring and control of computer systems, i.e., systems management, continues to grow at a rapid pace in all areas of commerce. An ongoing difficulty with managing computer systems is tracking changes in the system components and their configurations. There are many reasons system management solutions are adopted by companies including reducing customer and service downtime to improve customer service and staff and customer productivity, reducing computer and network costs, and reducing operating expenditures (including reducing support and maintenance staff needs). A recent computer industry study found that the average cost per hour of system downtime for companies was $90,000 with each company experiencing 9 or more hours of mission-critical system downtime per year. For these and other reasons, the market for system monitoring and management tools has increased dramatically and with this increased demand has come pressure for more effective and user-friendly tools and features.

User administration and user access control continue to cause efficiency and cost challenges for providers of system and network monitoring environments. User administration involves the management of the users within a client or customer environment that are provided access to view the results of system and network monitoring and, in some cases, to control the operation of the monitored system and network. User administration typically includes such tasks as adding new client users and providing and updating user passwords. User access control typically involves managing the level of access to the gathered monitoring data that each user is granted.

For example, it may be desirable to grant some client users privileges to view and control the entire client environment while for some users it is desirable to only grant limited access to a portion of the collected data. The burden placed on a monitoring service provider by these two functions can be tremendous as numerous clients are managed by the provider. Further, each client may request access privileges for numerous information technology and maintenance personnel to monitor and control their computing environment that potentially includes thousands of monitored systems and networks.

Presently, user administration and access control are controlled by the service provider from a central location and server. In practice, clients provide a listing of users and an operator at the service provider site adds the users and provides an active password. Every change to a client's user listing or even a change to the level of access privileges for a user is typically processed by the service provider operator. As can be appreciated, user administration can be a time-consuming function for the service provider with employees continually being added or removed from the listing. In some systems, the customer is provided the ability to add or remove users, but these systems have simply passed the consuming, one-tier management task on to the customer without providing enhanced efficiency or desired functionality. In many systems, access control is provided on an all or nothing basis with many users provided full access to view and/or control all of the monitored systems for the client. This is often undesirable due to the size and number of the monitored environment that may include thousands of monitored systems and networks. Generally, present monitoring systems do not provide effective means for assigning differing viewing and control privileges to different users.

Hence, there remains a need for an improved system and method for monitoring computer systems that meets the need for efficient and effective user administration and access control within a client environment. Preferably, such a system and method would provide increase client (or distributed) management of their users to improve each client's ability to manage their monitor personnel and control computer system security. Additionally, such a system and method would preferably provide for multi-tier access and administration control to more effective distribute these functions throughout a client environment and would provide each user with the ability to view portions of the client environment for which they have privileges and for which they have particular interest.

### SUMMARY OF THE INVENTION

To address the above and other deficiencies with existing monitoring systems, a self-monitoring system is provided that provides useful customer administration features that allow user management and access control functions to be distributed among the service provider and a number of assigned customer users or operators. Briefly, the customer administration features are provided by one or more administration tools or mechanisms operating within the service provider system or server. The administration tool operates in combination with a client and user database to provide three classes or access levels of customer users (in addition to an account manager or user at the service provider) with differing levels of access to gathered monitoring and asset data and to management over other users and, in some cases, the monitored systems.

In one embodiment, the user classes are labeled root administrator, domain administrator, and viewers with the root administrator having the highest viewing and user administration privileges, the domain administrators having fewer privileges (e.g., root administrator-like privileges but only over specified domains, networks, or defined subsets of the customer environment), and the viewer class having the lowest amount of privileges (e.g., the ability to view limited portions of the monitoring and asset data without the ability to control the system or administer users). Significantly, once the root administrator is assigned by the service provider, the customer has direct control over its users and their access to monitoring data, system management, and user administration. For example, the root administrator's privileges include viewing and controlling the entire customer system and assigning and administrating domain administrators and viewers. The domain administrator's privileges include viewing and controlling assigned domains and assigning and administrating viewers within their assigned domains. The viewers typically only have viewing privileges to assigned domains or portions of domains and no administrative functions (except possibly updating their own user profiles). In preferred embodiments, each user class has the ability to quickly filter the amount of information that is viewed by filtering the set of information for which they are granted access, such as by selecting one or more domains within the assigned set of domains (or otherwise defining a subset of the assigned customer environment) for viewing.

According to one aspect of the invention, a method is provided for distributing user administration to customer users of a monitoring system. A data structure such as a database is provided for storing user profiles for each customer or customer account. Each of the user profiles typically includes a user name, one or more domains or other segment of the monitored customer environment, and for each assigned domain a user class that defines user administration privileges for the user. The method further includes receiving login information from a customer user including a user name. Based on the user name, the user class of the user is determined. A request to administer, such as by adding a new user or modifying existing user profiles, is received from the user and the validity of the request is determined by comparing the user class of the customer user and the user class in the user profile to be added or modified. Typically, the administering user can only add or modify users having a user class with equal or less administering privileges. Further, a determination that the user profile being modified or added is within a domain for which the administering user has administering privileges. If the request is valid, the user profile is updated in the data structure, thereby allowing customer users to perform user administration.

### BRIEF DESCRIPTION OF THE DRAWINGS

FIG. 1 illustrates a self-monitoring service system with enhanced customer administration according to the present invention generally showing a service provider system and its services linked by networks and relays to a large number of monitored systems;

FIG. 2 illustrates one embodiment of a service system of FIG. 1 showing a customer administrator or customer administration mechanism within the service provider system that in combination with the client and user database provides many of the client user administration and access control functions of the invention;

FIG. 3 is a flow chart illustrating exemplary systems monitoring and customer administration functions provided by the systems of FIGS. 1 and 2;

FIG. 4 illustrates an account maintenance interface displayed by the customer administrator;

FIG. 5 illustrates a user maintenance interface providing a customer administrator a number of ways of viewing and managing customer users;

FIG. 6 illustrates a screenshot of a web page selected from the interface of FIG. 5 illustrating each domain or network and the users for those domains by access level or class;

FIG. 7 illustrates a screenshot of another web page selected from the interface of FIG. 5 illustrating each user assigned by the customer and providing domains for which the user has access privileges and listing what role or access level the user has for each domain;

FIG. 8 illustrates a screenshot of yet another web page selected from the interface of FIG. 5 illustrating each domain of the customer system and listing assigned users along with their access level or role; and

FIG. 9 illustrates a screenshot of an interface that the customer administrator provides to enable a customer user to select domains for obtaining reports or for maintaining users to allow the customer user to view monitoring, asset, and other reports for selected domains and systems.

### DETAILED DESCRIPTION OF THE PREFERRED EMBODIMENTS

The present invention is directed to a method and system of providing self-monitoring services to clients or customers with improved customer administration and user access control. Significantly, while account or customer management is retained by the service provider, many of the customer administration and user access control functions are distributed on a multi-tier or multi-class basis to the customer. In this fashion, the customer is able to more quickly and efficiently manage their users and monitoring activities over their own computing environment and these functions are distributed to the customer in a multi-class approach that effectively spreads the user and access control administration functions over a large enough number of users to reduce the risk of bottlenecks within the user system.

More specifically, a service system is provided that includes data collection devices within the customer system to periodically collect monitoring and asset information and to pass this information to a service provider system for processing and storage. The service provider system includes one or more mechanisms, such as a customer administrator and a customer and user database, that function to store for each customer account and user information that tracks each assigned user for each customer account and that indicates the user class or access level assigned to the user and which portions of the customer environment privileges have been assigned. The customer administrator then operates to accept login information for each user and grant that user data and system access corresponding to their user level in each domain or portion of the customer system or environment. Updates to the user profiles including changes in user class and privileges are processed by the customer administrator, which then updates the customer and user database for use in future logins by customer users.

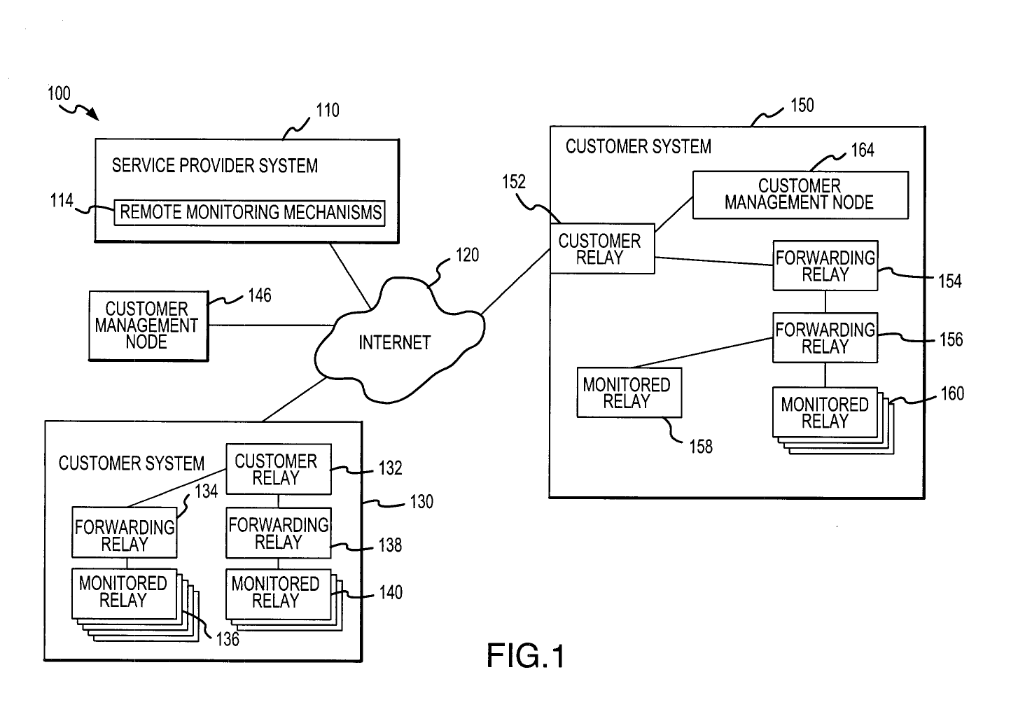

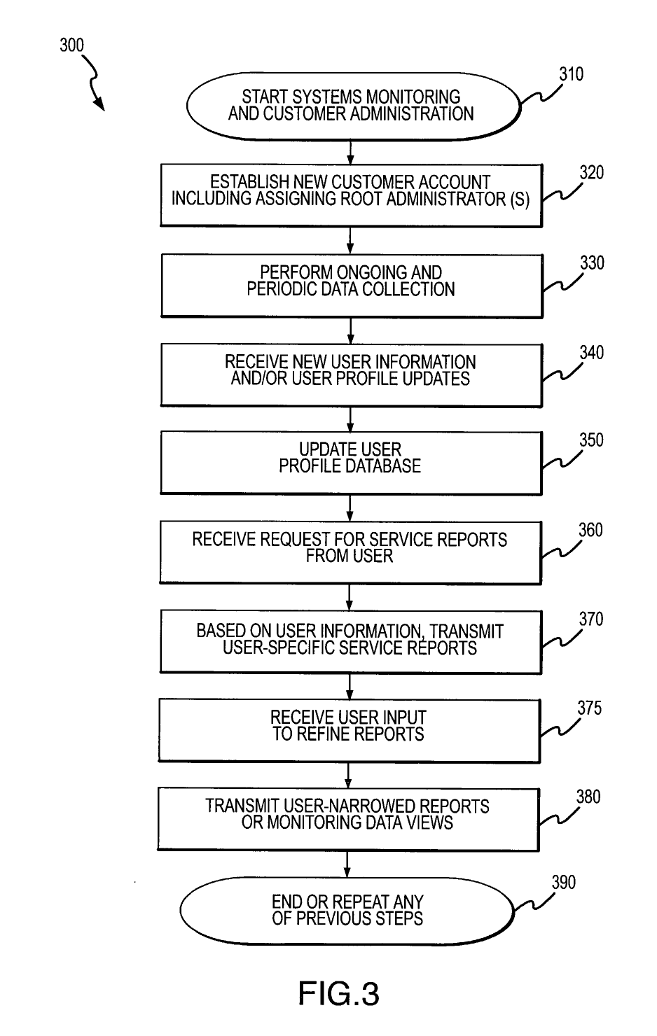

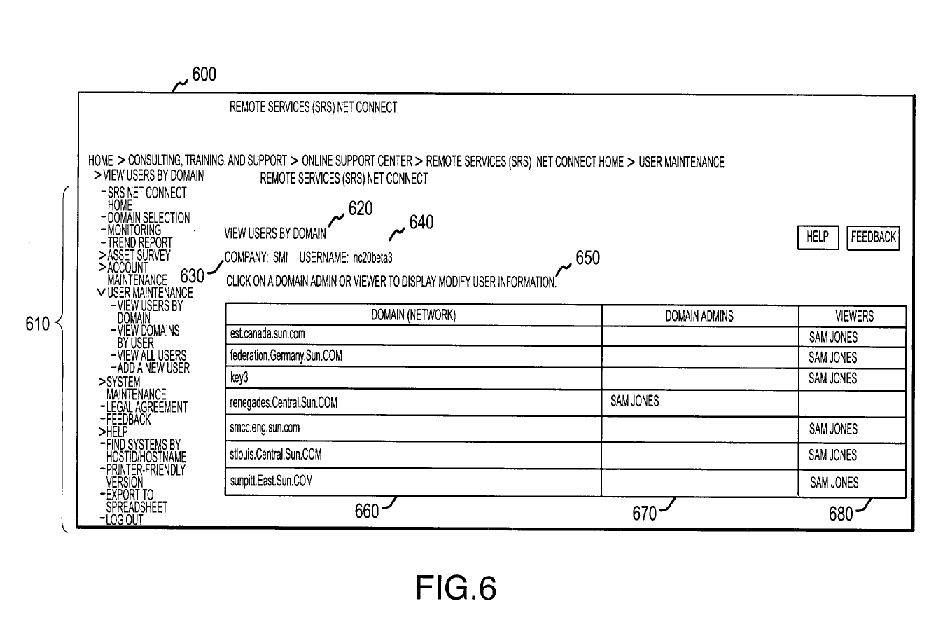

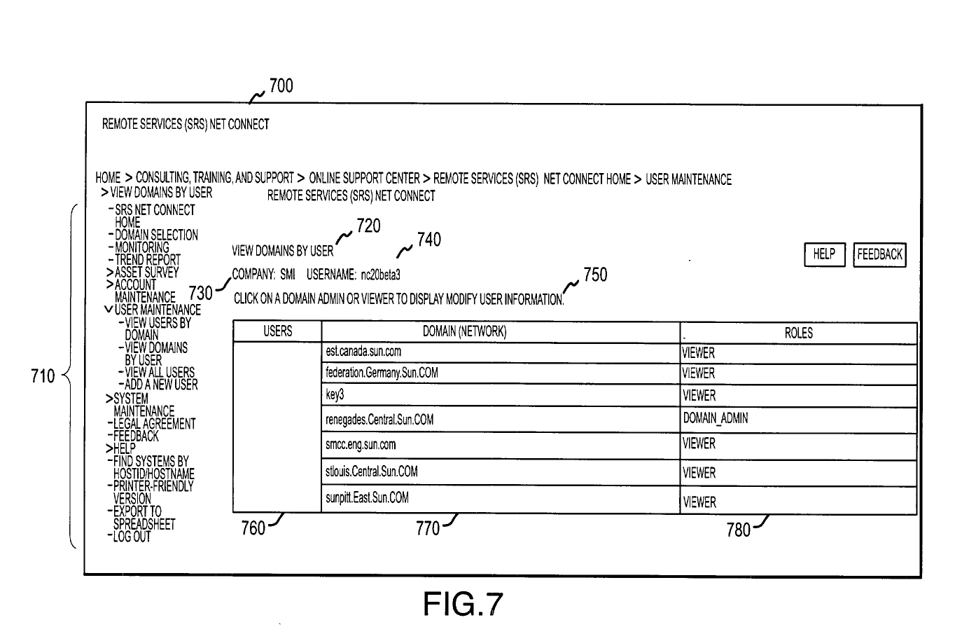

In the following description, the system is described as utilizing specifically configured forwarding or fan-out relays within the customer system to provide a cascaded pipeline that controls the transmission of data and/or messages between a monitored relay or system and a service provider system and allows the customer system to be readily scaled up and down in size to include hundreds or thousands of monitored systems and nodes. However, other network and data transmission configurations and/or techniques may be used to practice the invention. With this brief overview in mind, the following description begins with a description of a typical service system of the invention with reference to FIG. 1 and continues with a more specific description of the various components included within a service provider system, a forwarding relay, and a monitored system to provide the desired functions of the invention. User administration and user-controlled, selective viewing of monitoring and asset information are then described fully with reference to FIGS. 3-9.

Referring to FIG. 1, a self-monitoring service system 100 is shown that according to the invention provides distributed customer administration. The system 100 includes a service provider system 110 with remote monitoring mechanisms 114 that function to process collected data and provide event, alert, trending, status, and other relevant monitoring data and asset survey information in a useable form to monitoring personnel, such as via customer management nodes 146, 164. As will become clear, the monitoring personnel or customer users are assigned user classes or access levels that define for each user their privileges for accessing and controlling the gathered information and the monitored systems.

The service provider system 110 is linked to customer systems or sites 130, 150 by the Internet 120 (or any useful combination of wired or wireless digital data communication networks). The communication protocols utilized in the system 100 may vary to practice the invention and may include for example TCP/IP and SNMP. The service provider system 110 and customer systems 130, 150 (including the relays) may comprise any well-known computer and networking devices such as servers, data storage devices, routers, hubs, switches, and the like. The described features of the invention are not limited to a particular hardware configuration or to particular hardware and software components.

The service system 100 is adapted to control data transmissions, including user login messages, user profile additions and modifications, and monitoring reports provided based on user classes, within the customer systems 130, 150 and between the service provider system 110 and the customer systems 130, 150. In this regard, the system 100 includes a cascaded pipeline architecture that includes within the customer systems 130, 150 linked customer or Internet relays 132, 152, forwarding (or intermediate or fan-out) relays 134, 138, 154, 156, and monitored relays 136, 140, 158, 160. The monitored relays 136, 140, 158, 160 are end nodes or systems being monitored in the system 100 (e.g., at which configuration, operating, status, and other data is collected). The forwarding relays 134, 138, 154, 156 are linked to the monitored relays 136, 140, 158, 160 and configured to support (or fan-out) monitored systems to forwarding relay ratios of 500 to 1 or larger. In one embodiment, the pipeline is adapted to control the transmission of data or messages within the system, and the forwarding relays act to store and forward received messages (from upstream and downstream portions of the pipeline) based on priorities assigned to the messages. The customer relays 132, 152 are positioned between the Internet 120 and the forwarding relays 134, 138, 154, 156 and function as an interface between the customer system 130, 150 (and, in some cases, a customer firewall) and the Internet 120 and control communication with the service provider system 110.

The system 100 of FIG. 1 illustrates that multiple forwarding relays 134, 138 may be connected to a single customer relay 132 and that a single forwarding relay 134 can support a large number of monitored relays 136 (i.e., a large monitored system to forwarding relay ratio). Additionally, forwarding relays 154, 156 may be linked to provide more complex configurations and allow more monitored systems to be supported within a customer system 130, 150. Customer management nodes 146, 164 used by users for logging into the system and displaying and, thus, monitoring collected and processed system data may be located anywhere within the system 100 such as within a customer system 150 as node 164 is or directly linked to the Internet 120 and located at a remote location as is node 146. In a typical system 100, more customer systems 130, 150 would be supported by a single service provider system 110 (e.g., many customer environments or accounts) and within each customer system 130, 150 many more monitored relays or systems (e.g., a typical customer environment may include thousands of components and systems organized in a variety of ways such as by domain, network, business department, building, geography, and the like) and forwarding relays would be provided, with FIG. 1 being simplified for clarity and brevity of description.

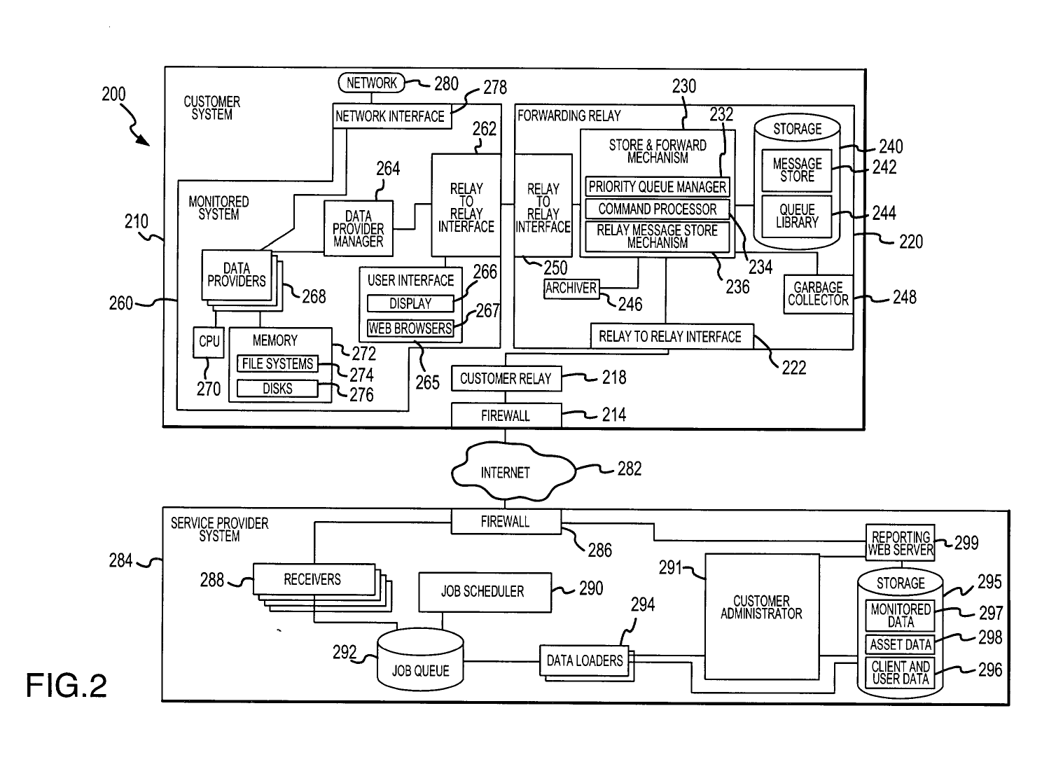

FIG. 2 shows a monitoring service system 200 that includes a single customer system 210 linked to a service provider system 284 via the Internet 282. FIG. 2 is useful for showing more of the components within the monitored system or relay 260, the forwarding relay 220, and the service provider system 284 that function separately and in combination to facilitate collection and transmittal of monitoring and asset data and to provide the customer administration and data viewing features of the invention.

As shown, the customer system 210 includes a firewall 214 connected to the Internet 282 and a customer relay 218 providing an interface to the firewall 214 and controlling communications with the service provider system 284. The customer system 210 includes a forwarding relay 220 linked to the customer relay 218 and a monitored system 260. The forwarding relay 220 functions, in part, to provide a useful communication link between the monitored system 260 and the service provider system 284 and accepts data from upstream and downstream sources and reliably and securely delivers it to the recipient. Throughout the following discussion, the monitored system 260 will be considered the most upstream point and the service provider system 284 the most downstream point with data (i.e., “messages”) flowing downstream from the monitored system 260 to the service provider system 284.

The forwarding relay 220 accepts data from upstream and downstream sources and reliably and securely delivers it downstream and upstream, respectively. The relay 220 caches file images and supports a recipient list model for upstream (fan-out) propagation of such files. The relay 220 manages the registration of new monitored systems and manages retransmission of data to those new systems. In some embodiments, the forwarding relay 220 implements a priority scheme to facilitate efficient flow of data within the system 200. The forwarding relay 220 includes two relay-to-relay interfaces 222, 250 for receiving and transmitting messages to connected relays 218, 260. A store and forward mechanism 230 is included for processing messages received from upstream and downstream relays and for building and transmitting messages. This may be thought of as a store and forward function that is preferably provided within each relay of the system 200 (and system 100 of FIG. 1) and in some embodiments, such message building and transmittal is priority based. To provide this functionality, the store and forward mechanism 230 includes a priority queue manager 232, a command processor 234, and a relay message store mechanism 236 and is linked to storage 240 including a message store 242 and a priority queue library 244.

Briefly, the priority queue manager 232 is responsible for maintaining a date-of-arrival ordered list of commands and messages from upstream and downstream relays. The command processor 234 coordinates overall operations of the forwarding relay 220 by interpreting all command (internal) priority messages and also acts as the file cache manager, delayed transmission queue manager, and relay registry agent. The relay message store mechanism 236 acts to process received message and commands and works in conjunction with the priority queue manager 232 to build messages from data in the message store 242 based on the priority queue library 244 and to control transmission of these built messages. The mechanism 236 functions to guarantee the safety of messages as they are transmitted within the system 200 by creating images of the messages in storage 240 (e.g., on-disk images) and implementing a commit/destroy protocol to manage the on-disk images. In general, a “message” represents a single unit of work that is passed between co-operating processes within the system 200. The priority queue manager 232 functions to generate priority queues (which are stored in library 244). This allows the relay 220 to obtain a date-ordered set of priority queues directly from the mechanism 230.

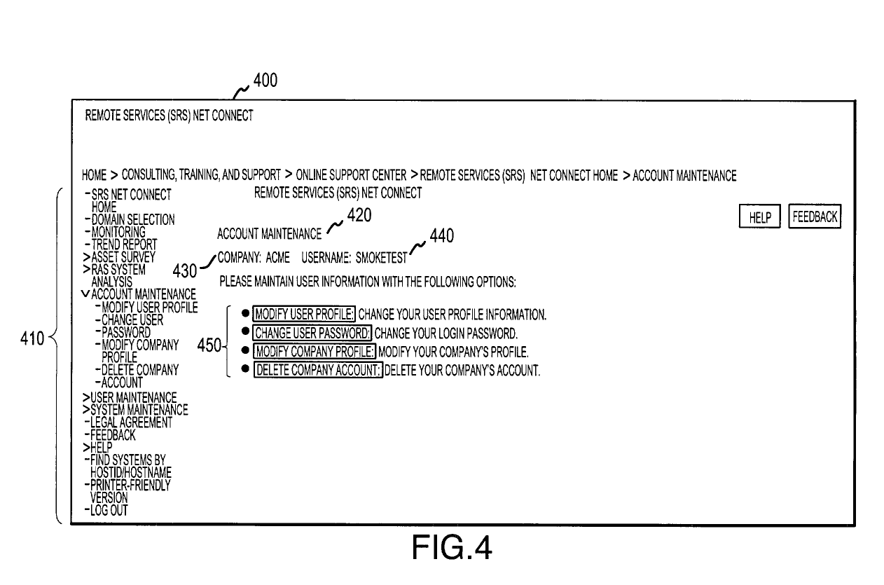

Generally, the message store 242 stores all messages or data received from upstream and downstream sources while it is being processed for transmittal as a new message. The store 242 may take a number of forms. In one embodiment, the store 242 utilizes a UNIX file system to store message images in a hierarchical structure (such as based on a monitored system or message source identifier and a message priority). The queue library 244 implements a doubly-linked list of elements and allows insertion to both the head and tail of the list with searching being done sequentially from the head of the queue to the tail (further explanation of the “store” function of the forwarding relay 220 is provided with reference to FIGS. 3 and 4). Messages are typically not stored in the queue library but instead message descriptors are used to indicate the presence of messages in the message store 242. The queue manager 232 may create a number of queues in the library 244 such as a queue for each priority level and extra queues for held messages which are stored awaiting proper registration of receiving relays and the like. A garbage collector 248 is provided to maintain the condition of the reliable message store 242 that involves removing messages or moving messages into an archival area (not shown) with the archiver 246 based on expiry policy of the relay 220 or system 200.

In some embodiments, the forwarding relay 220 with the store and forward mechanism 230 functions to send information based upon the priority assigned (e.g., by the transmitting device such as the monitored system 260 or service provider system 284) to the message. Priorities can be assigned or adjusted based on the system of origination, the function or classification of the message, and other criteria. For example, system internal messages may be assigned the highest priority and sent immediately (e.g., never delayed or within a set time period, such as 5 minutes of posting). Alerts may be set to have the next highest priority relative to the internal messages and sent immediately or within a set time period (barring network and Internet latencies) such as 5 minutes. Nominal trend data is typically smaller in volume and given the next highest priority level. High-volume collected data such as configuration data is given lowest priority. Of course, the particular priorities assigned for messages within the system 200 may be varied to practice the prioritization features of the present invention. Again, it will be understood that the customer administration features of the invention are not dependent on the particular arrangement of the forwarding relay or the use of prioritization while these features are useful for controlling communications between customer systems 210 and the service provider system 284.

In some embodiments, the system 200 is adapted for gathering and reporting asset data and in some cases, for determining and reporting changes in assets of the monitored system 260 such as between two comparison points (e.g., two user-selected dates and/or times, two user-selected surveys, and the like). Assets of a computer system and/or network may include a wide range of hardware and software components and may be varied significantly to practice the present invention. For example, but not as a limitation, the system 200 may be configured to report or display (such as at user interface 265) fundamental changes of the monitored system 260 including a CPU delta, a disk delta, a file system delta, a system packages delta summary, a system patches delta detail, and a network delta. The CPU delta reports or displays CPU change information such as changes in the CPU numbers, types, board numbers, frequencies, sizes of caches, and other CPU information. The disk delta reports or displays hard disk change information such as changes in capacity, device paths, disk models, serial numbers, and revisions. The file system delta reports or displays file system change information such as the changes in the device path(s), mount directories, file system type, total blocks, block size, fragment size, total inodes, and other file system information. The system packages delta summary reports or displays system package change information pertaining to all system packages based on provider, level of installation, and other reporting criteria. The system patches detail reports or displays system patch change information such as patch numbers, installed and current patch revisions with information on the currently installed patches, and other patch characteristics. The network delta reports or displays changes in network interfaces, network operations, and the like.

The monitored system 260 typically includes components to be monitored and surveyed such as one or more CPUs 270 running one or more packages with a plurality of patches, memory 272 having file systems 274 (such as storage area networks (SANs), file server systems, and the like) and disk systems 276, and a network interface 278 linked to a customer or public network 280 (such as a WAN, LAN, or other communication network). A user interface 265 is included to allow a client user to communicate, e.g., login and request information, with the service provider system 284 (and specifically with the customer administrator 291 as discussed with reference to FIGS. 3-9) and to allow viewing of monitoring reports and asset survey information and asset survey delta reports of the monitored system 260. The user interface 265 typically includes a display 266 (such as a monitor) and one or more web browsers 267 to allow viewing of screens of collected and processed data including asset survey delta reports and monitoring information including events, alarms, status, trends, and other information useful for monitoring and evaluating operation of the monitored system 260. The web browsers 267 provide the access point for users of the user interface 265.

Data providers 268 are included to gather monitoring information and perform asset surveys and collect operating and other data from the system 260. A data provider manager 264 is provided to control the data providers 268 and to transmit messages to the forwarding relay 220 including assigning a priority to each message. Preferably, the data providers 268 and data provider manager 264 and the relays 220, 218 consume minimal resources on the customer system 210. In one embodiment, the CPU utilization on the monitored system 260 is less than about 0.01 percent of the total CPU utilization and the CPU utilization on the relay system is less than about 1 percent of the total CPU utilization. The data providers 268 typically collect data for a number of monitoring variables such as run queue and utilization for the CPU 270, utilization of memory 272 including information for the file systems 274 and disks 276, and collision, network errors, and deferred packets for the network interface 278. The data providers 268 typically collect configuration data and other asset survey data (i.e., all data necessary to create the asset survey delta reports discussed above). The data providers 268 operate on a scheduled basis such as collecting trend data (e.g., monitoring variable information) every 10 minutes and only performing asset survey once a week or some relatively longer period of time. In some cases, the client user via the user interface 265 or a service provider system 284 operator may adjust asset survey performance periods and/or initiate asset surveys (i.e, operation of the data providers 260 useful for collection of asset data). The data provider manager 264 functions to coordinate collection of data by the data providers 268 and to broker the transmission of data with the relay 220.

The service provider system 284 is linked to the Internet 282 via the firewall 286 for communicating messages with the customer relay 218 and the forwarding relay 220. The service provider system 284 includes receivers 288 which are responsible for accepting data transmissions from the customer system 210 and brokering the data to the appropriate data loaders 294 and to the customer administrator 291. Typically, received messages or jobs are queued in job queue 292 and the job queue 292 holds the complete record of the data gathered by a provider 268 until it is processed by the data loaders 294. The job scheduler 290 is responsible for determining which jobs are run and in which order and enables loaders 294 to properly process incoming data. The data loaders 294 function to accept data from the receivers 288 and process the data into final format which is stored in storage 295 as client and user data 296, monitored data 297, or asset data 298. The data loaders 294 are generally synchronized with the data providers 268 with, in some embodiments, a particular data loader 294 being matched to operate to load data from a particular data provider 268.

The client and user data 296 generally is a database or other data storage architecture used to store information for each client or account that is then used by the customer administrator 291 for providing access to the monitored and asset data 297, 298 based on a user class. The user class in turn is then used to identify the privileges provided to each user for a client or a customer account. While the specific organization of the client and user database 296 is not important, the database 296 preferably is arranged to include a number of user records or files that include an account number or identifier that links the user to a customer account, a user identification and/or user password, and a user class or access level. If the user class is lower than the root class (which by definition has access to all information associated with the customer account), the database 296 preferably includes for each user a user class for each portion (e.g., domain, network, system, department, geographical location, or other division of the customer environment) of the customer environment or system 210 for which the particular user has been assigned access privileges. In this fashion, each user may be assigned privileges to different portions of the customer environment or system 210 and, further, may be assigned differing access privileges in each of these system portions. For example, if user classes of root administrator, domain administrator, and viewer are implemented, a user may be granted domain administrator privileges in one domain while only being granted viewer privileges in other domains. The number of combinations of user classes that may be granted is nearly limitless and provides significant control to the client over its system monitoring functions.

According to an important aspect of the invention, the service provider system 284 includes the customer administrator or administration mechanism 291 in communication with the data loaders 294, storage 295, and reporting web server 299. The function of the customer administrator 291 is discussed fully with reference to FIGS. 3-9. Briefly, however, the administrator 291 acts to manage customer accounts including assigning highest access level users, such as root administrators, to process new user profiles received from customers such as via user interface 265 and update the client and user data 296 to reflect current users and their user classes and profile information, and to control access for each customer user to the monitored data 297 and asset data 298 based on login information and the current client and user data 296.

The customer administrator 291 in some embodiments creates all reports provided to the user interface 265 but in other preferred embodiments, the administrator 291 works with the reporting web server 299 for communicating with the user interface 265 to request and receive user input (such as reporting login information and report narrowing or filtering input including domain or other subsystem identification for the customer system). The administrator 291 responds to received user input to determine which portion of the monitored systems the user has access to and which portions they are requesting access. This information is passed to the reporting web server 299 that generally functions to culminate all the processed data and transmit or report it to the user interface 265.

The types of reports may vary but typically include time-based monitoring data for trend analysis, system configuration data for system discovery and planning, and time-based monitoring data evaluated against a set of performance level metrics (e.g., alerts) and may be in HTML or other format. The specific formatting of the monitoring, trending, asset, and other reports is not as relevant to this invention as is the multi-levels of user access and ability of the user to quickly and effectively select portions of the gathered information to view. While shown as separate devices, the functions of the receivers 288, job scheduler 290, asset survey mechanism 291, data loaders 294, and reporting web server 299 may be provided any number of mechanisms that may be located on one or more servers or other computing devices. Further, the memory 296 may be located in one or more data storage devices within the system 284 or remote but linked to the system 284.

Referring now to FIGS. 3-9, the operation of the systems 100 and 200 are described with particular detail provided for the operation of the service provider system 200 and the customer administrator 291. FIG. 3 illustrates an exemplary monitoring and administration process 300 according to the present invention. According to an important feature of the invention, the administration process 300 retains account management functions at the service provider 284 but provides for multi-tiered or multi-class user administration functions to be distributed to and/or controlled directly by the customer users at the customer system 210, such as via communications with user interface 265. In general, this is achieved by separating customer users into three or more user classes or access levels having differing amounts of data viewing and user administration privileges. Further, lower level classes having fewer privileges are generally associated with or assigned by portions or subsets of the overall customer environment, such as by customer domains, networks, systems, business organizations, geographic areas, buildings, and the like.

In the embodiment described with reference to FIGS. 4-9, three user classes are utilized including a root administrator, a domain administrator, and a viewer. The root administrator is generally considered the master user and has the entire set of user privileges including viewing all information or reports for the customer system or environment 210 and user administration functions including control of adding and deleting new users, assigning user profiles and privileges, and managing the customer or company profile. The domain administrator has fewer privileges than the root administrator but typically can view and control all data and systems within the corresponding domain and has user administration functions including creating, modifying, and deleting users with equal or less privileges within the domain for which they are responsible. For example, a domain administrator can assign new domain administrators and viewers for their domain. Further, there can be more than one domain administrator for any particular domain and each user can be a domain administrator for more than one domain. A viewer has fewer privileges than a domain administrator and typically can only see (but not control, such as clear alerts) reports for systems in the domain where they have privileges and cannot administer users. There can be many viewers per domain and each user may be designated as a viewer in multiple domains and may have a higher user class in other domains. In this embodiment, each domain administrator and viewer is linked to a network domain name but in other embodiments other divisions or subsets of the customer environment 210 may be utilized to provide differing access levels to differing portions of the customer environment 210.

At 310, the process 300 begins typically by a customer requesting that system monitoring and customer administration services be provided by the service provider. At this time, the customer system 210 is configured to include the data providers 268, the forwarding relays 220, the customer relay 218, and other software and, if applicable, hardware components and a communication link with the service provider system 284 is established such as via the Internet 282 and firewalls 214, 286. At 320, the requesting customer provides company information for establishing a customer account and profile information for one or more people that are to be assigned as root administrators. The client and user database 296 is updated to include the customer account and to include information (including login information) for the root administrator(s) of the customer. Typically, step 320 is performed by an account manager of the service provider system 284 with the account manager having the “privileges” of being able to add, modify, and delete customer accounts, to view and control all reports from every customer account, and to fully administer the users of each customer account (in some embodiments, the ability of the account manager to administer users is limited to assigning root administrators).

Once an account is established, the process 300 continues at 330 with an initial gathering of monitoring and asset data that is stored as monitoring and asset data 297, 298 in storage 295. As discussed previously, monitoring data 297 is typically gathered relatively frequently or on an almost ongoing basis while the asset data 298 is gathered periodically, such as once a week. The monitoring and asset data 297, 298 is then processed to provide a number and variety of monitoring, trending, asset, asset deltas, and other reports that are provided to the users within the customer system 210 at the user interface 265.

At 340, new user information and/or user profile updates are received at the service provider system 284 and at 350, the client and user database 296 is updated to reflect the new users and/or updated user profiles. Generally, steps 340 and 350 may be thought of as account and user maintenance functions that are being initiated and controlled by the customer users. At the beginning of step 340, a user logs into the service or application on the service provider system 284 such as by connecting via the Internet 282 to the system 284, e.g., the system 284 address, by requesting to login, and then entering a user name or identification and a password. The customer administrator 291 then verifies that the login information corresponds to a user file in the client and user database 296 and if so, provides a home page (not shown) for the monitoring service from which additional functions such as account or user maintenance may be selected. With the user name, the customer administrator 291 is able to determine the proper customer account and the user's assigned access level or user class and associated privileges.

FIG. 4 illustrates a screen or page 400 that may be displayed by the customer administrator 291 and web server 299 at the user interface 265 to enable the logged-in user to select account maintenance functions as indicated at 420 with the company identification provided at 430 and the user identification provided at 440. At 410, a pulldown listing of links from this page 400 are provided including those displayed in area 450 including modifying a user profile, changing a user password, modifying the company profile, and deleting a company account. In most embodiments, the root administrator is the only user that will be provided access to each of these account maintenance functions, i.e., the displayed page 400 is that shown to a root administrator or other user classes would not be able to link to some of the functions. The customer administrator 291 functions to use limit the access (such as by only displaying available functions or inactivating links) of each user by their assigned user classes. As to account maintenance 400, viewers and domain administrators would be able to modify their own user profile and their user password while the root administrator could also modify the company profile and delete or cancel the company's account.

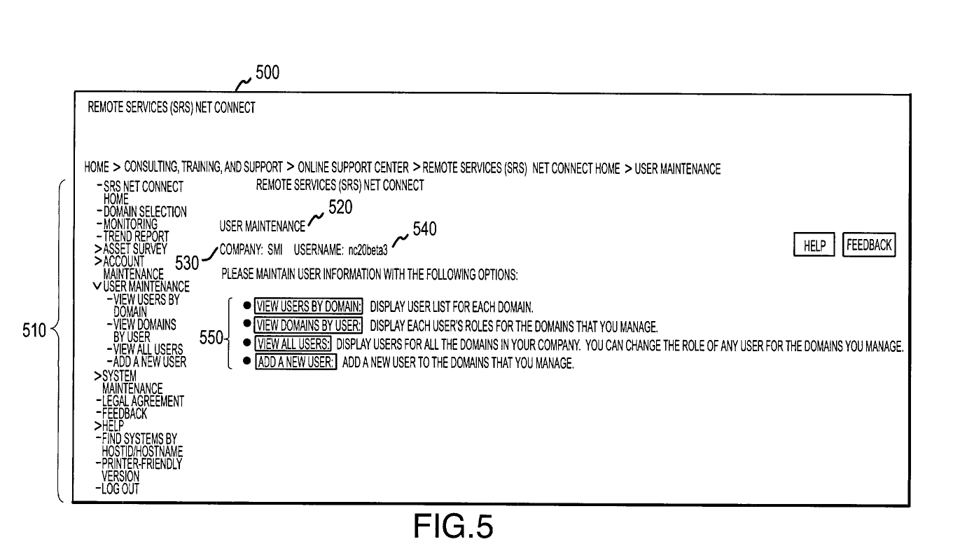

The user maintenance or administration function provided at 340 and 350 is an important aspect of the invention and is explained with reference to FIGS. 5-8. As with account maintenance, the amount of access or privileges provided to each user is based on their login information and the user class or classes assigned and stored in the client and user database 296. Further, according to the invention, the user information for the customer account may be accessed in a number of ways that facilitates the administration of users. FIG. 5 illustrates the main user maintenance page 500 as indicated at 520 and by pulldown link list 510. The customer account being accessed is indicated at 530 and the user accessing the customer administrator 29 is indicated at 540. Again, this page 500 provides all of the user administration functions that would be displayed and made available to a root administrator but necessarily to a domain administrator or to a viewer. Each of these administration functions or options, e.g., viewing users by domain, viewing domains by user, view all users, and add a new user as indicated at 550, are explained in detail but it should be remembered that a viewer is not able to add new users and a domain administrator is only able to add new users in the domains for which it is assigned as a domain administrator. Further, viewers and domain administrators typically can only view users and domains for which they have privileges.

When “View Users by Domain” is selected in page 500, the view users by domain page 600 is displayed at interface 265 as indicated at 620 and by pulldown link list 610. Generally, the page 500 allows the user or administrator to view a list of assigned users for each domain within the customer environment 210 for root administrators and within the assigned domains for domain administrators and viewers. Again, the customer account is indicated at 630 and the user's identification is provided at 640. The text at 650 explains that in the illustrated embodiment of the page 600 the user may select a user to view their user's profile (and modify the information if they have that privilege over that user). As shown, the page 600 includes a three-column table containing a list of domains in column 660, a list of domain administrators for each domain in column 670, and a list of viewers for each domain in column 680.

When “View Domains by User” is selected in page 500, the page 700 is displayed on interface 265 as indicated at 720 and the pulldown link list 710. The page 700 identifies the customer account at 730 and user at 740. Again, the user names in the table are links as indicated in the text at 750 allowing a user administrator to view and, if appropriate and allowed, to modify their user profile. Again, a three-column table is provided with column 760 listing all the users that have been assigned within the customer account indicated at 730 (with only one user being shown for simplification but not as a limitation). The second column 770 indicates in which domains the user in column 760 has been granted access or privileges. The third column 780 indicates the role or user class that the user has been assigned in each of the domains of column 770. Again, the domains included in column 770 are only the domains for which the user indicated at 740 has been assigned or which they manage users. In this fashion, the user information from the database 296 is filtered to only show the domains that are relevant to the logged-in user.

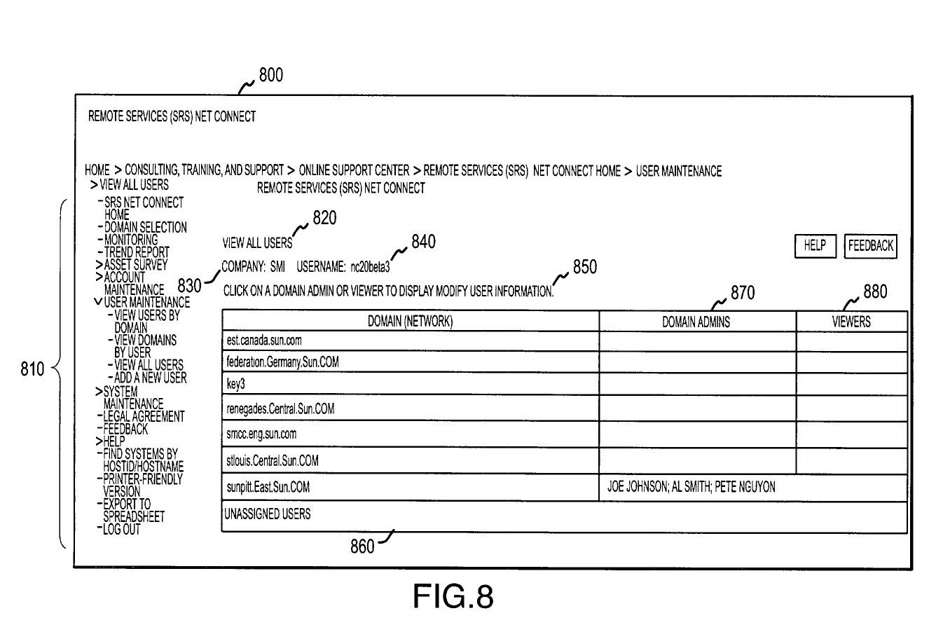

In contrast, page 800 in FIG. 8 displays all the users for the customer account and in some embodiments, displays users (or potential users) that have not yet been assigned a user class or role. At 810 and 820, page 800 is identified as the “View All Users” page and at 830 and 840 the present customer account and user is indicated. At 850, it is pointed out that the user names in the table may be selected to link to a user profile modification page to modify data and/or change the user class or role or assign the user to another domain. The page 800 includes a three-column table that lists in column 860 all of the domains in the customer account 830, in column 870 lists the domain administrators for each domain in column 860, and in column 880 lists all viewers for each domain in column 860 (as well as all unassigned users in the last row of the table).

When “Add a New User” is selected on user maintenance page 500, a page (not shown) with a form for user profile information is displayed on user interface 265 to be completed. Again, customer users can only add users if they are root administrators who are given the privilege of adding domain administrators or viewers to any domain or domain administrators who are given the privilege of adding domain administrators or viewers to domains for which they are assigned as domain administrator. So, at 340 and 350 of process 300, the customer administrator 291 acts to verify such as by user identification that the user has the ability or privilege to add the new user prior to updating the client and user database 296. Similarly, modification of a user profile (including deletion) at 340 and 350 requires that the user have that user administration privilege and this is again verified by the customer administrator 291 prior to updating the database 296. Note, in some embodiment, the root administrator is the only user with the ability to delete domain administrators. The user profile modification is typically achieved by selecting a user from one of the pages 600, 700, or 800 and then modifying data in a displayed profile form (not shown). The form is then submitted to the service provider system 284 by the user at 340 for updating the database 296 at 350.

Referring again to FIG. 3, the process 300 continues at 360 with the receipt of a request for monitoring, asset, or other reports (e.g., service reports) at the service provider system 284. These service reports are typically requested by the user from any of number of screens (such as the pulldown link list of pages 400, 500, 600, 700, or 800) at the interface 265. Again, the user has previously entered login information that the customer administrator 291 uses to retrieve account and user information, including the assigned user classes and domains for the user, from the client and user database 296. This is significant because the data and reports provided to the user are filtered or restricted by the user class and domain for which the user has been assigned access privileges. At 370, the customer administrator 291 in combination with web server 299 transmits user-specific service reports based on the login information and corresponding user classes and assigned domains. For example, the requesting user of a customer account having ten domains may be a domain administrator for one domain and a viewer for another domain. A report for this user would provide full viewing and control access to the one domain but only viewing access to the other domain (and the other eight domains within the customer system 210 would not be reported at all because the user has been assigned no privileges for these domains) In this fashion, the customer administrator 291 and system 284 function to quickly filter and report only data of interest to the user and for which they have privileges, thereby enhancing monitoring efficiency while increasing security and control granted to the customer (e.g., the root administrator and domain administrators who can be selective in assigning privileges).

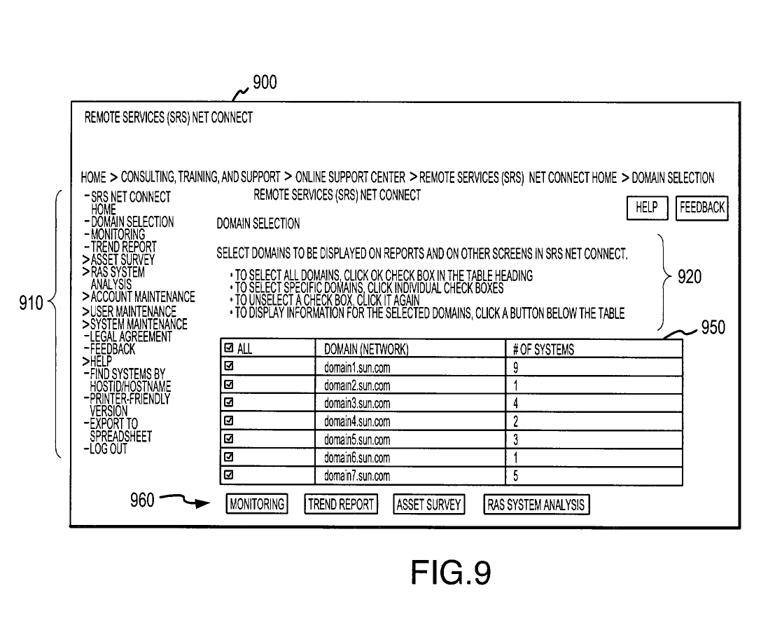

In many cases, it is desirable for a user to be able to further focus in on a particular portion (such as a domain) of the customer environment for which they have access privileges. For example, a user may have domain administrator or viewer access to a number of domains (or other segments or divisions for customer environment) but want to track or monitor one or more of these domains. The customer administrator 291 provides this functionality by allowing the user to go to a domain selection page from the pulldown link list of pages 400, 500, 600, 700, or 800. One embodiment of such a page 900 is shown in FIG. 9 as indicated in listing 910. The text at 920 teaches that the user can choose which domains, i.e., subsets of the set of systems or domains for which they have access in the customer system 210, are to be included in subsequently selected or requested reports. In the table, column 930 provides boxes for selecting all domains for which the user has access privileges, column 940 lists the user's available domains, and column 950 provides the additional information of the number of systems included in each domain.

As shown at 960, the user after making the domain filtering or narrowing selection can choose which type of reporting to request from the service provider system 284. At step 375 the user (such as by selecting one of the report buttons) transmits the reporting narrowing input (e.g., domain or environment subset selection) to the service provider system 284. At 380, the customer administrator 291 with the reporting web server 299 acts to retrieve appropriate monitored and asset data 297, 298 based both on user information and on the input narrowing information. In this manner, the user is able to quickly reduce the volume of information that is reported and displayed on interface 265 to view specific information, thereby significantly improving the efficiency of their monitoring efforts. At 390, the process is ended or any of the process 300 steps may be repeated. For example, new customer accounts can be added at any time and data gathering is continued typically as long as the customer has an active account. Hence, generally, the order of the process 300 steps are performed is not mandatory and at least some of the steps can be performed concurrently.

Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention, as hereinafter claimed.

We claim:

1. A method of administering customer users within a monitoring system, comprising:
providing a data structure storing a plurality of user profiles, wherein each of the user profiles includes a user name identifying the customer user and a user class defining user administration privileges of the customer user;
receiving login information from a customer user of the monitoring system, wherein the login information includes the user name for the login customer user;
based on the received user name, determining from the data structure the user class of the login customer user;
receiving a user modification request from the login customer comprising a modification of one of the user profiles in the data structure or an addition of one of the user profiles;
determining validity of the user modification request based on the user class of the login customer user and the user profile addition or modification; and
when the user modification request is determined valid, updating the user profiles of the data structure with information in the user modification request.

2. The method of claim 1, wherein the validity determining includes comparing the user class of the user profile identified in the addition or modification request with the user class of the login customer to verify the login customer user has the user administration privileges at least as great as the user class in the identified user profile.

3. The method of claim 2, wherein the user class is selected from the group consisting of a root administrator, a domain administrator, and a viewer and wherein the root administrator user class has user administration privileges to add or modify the domain administrators and the viewers, the domain administrator user class has user administration privileges to add or modify the domain administrators and the viewers, and each of the viewers has the user administration privileges to modify only their corresponding user profile.

4. The method of claim 1, wherein each of the user profiles further includes a customer account identifier identifying a customer environment being monitored by the monitoring system, the customer environment being separated into a plurality of divisions having division identifiers, and wherein each of the user profiles includes one of the division identifiers associated with the user class.

5. The method of claim 4, wherein the validity determining includes comparing the division identifier associated with the user class of the login customer user with the division identifier associated with the user class of the user profile in the addition or modification request.

6. The method of claim 4, wherein each of the user profiles in the data structure is configured for storing a plurality of the user classes and associated ones of the division identifiers.

7. The method of claim 4, wherein the divisions are domains of the customer environment and the division identifiers are domain names.

8. A method of reporting monitoring and asset data gathered from customer system and network environments to customer users, comprising:
receiving login information from a user;
processing the login information to determine a customer account corresponding to one of the environments and a user identification;
using the customer account and the user identification to search a client and user data structure to determine an access level for the user;
receiving from the user a request for a report of information gathered from the one customer environment;
generating the requested report based on the user access level; and
transmitting the generated report to the user.

9. The method of claim 8, wherein the one customer environment includes a plurality of system groupings and wherein the user is assigned an access level for the system groupings indicating the presence or absence of viewing privileges for the user for each of the system groupings.

10. The method of claim 9, wherein the generating comprises including the gathered information for the system groupings for which the user has the viewing privileges.

11. The method of claim 9, wherein the system groupings are domains of the one customer environment.

12. The method of claim 11, further including receiving from the user a selection of the domains to include in the requested report, the selection defining a set of the domains for which the user has the viewing privileges.

13. The method of claim 12, further including transmitting to the user a listing of the domains for which the user has the viewing privileges, wherein the user selection is created from the listing.

14. A method in a computer system for communicating with a user of a systems monitoring service during customer-directed user maintenance, comprising:
presenting a prompt to the user requesting a submission of a user name;
determining a customer account corresponding to a monitored computer environment from the submitted user name;
determining a user class assigned to the user defining a plurality of user administration functions within the customer account; and
presenting a user maintenance screen to the user including selectable links to additional user maintenance screens based on the user administration functions.

15. The method of claim 14, wherein the monitored computer environment includes a plurality of systems organized in domains and users in the customer account are assigned user classes linked to particular ones of the domains.

16. The method of claim 15, wherein the additional user maintenance screens include a screen for adding new users having prompts for entering user profile information for a new user including a user class and one of the domains and further including receiving entered user profile information from the user, comparing the user class of the user with the user class of the new user, and based on the comparison, adding the new user profile to the customer account.

17. The method of claim 14, wherein the additional user maintenance screens include a screen for viewing users in the customer account by the domains, and further including after receiving the user selection, presenting to the user a set of the domains of the monitored computer environment with a listing of assigned ones of the users, wherein the domain set is selected based on the user class and the corresponding domains of the user.

18. The method of claim 17, further presenting an indication of the user class of the assigned ones of the users for each of the domains.

19. The method of claim 14, wherein the additional user maintenance screens include a screen for viewing assigned users along with the users assigned domains and user class for the assigned domains, and further including presenting to the user a set of the assigned users with a listing for each of the assigned users of the assigned domains and the user class for each of the assigned domains.

20. The method of claim 19, wherein the set of the assigned users presented is determined from the domains of the assigned users determined to be assigned to the user.
